(19) United States
(12) Patent Application Publication
(10) Pub. No.: US 2003/0005321 A1
(43) Pub. Date: Jan. 2, 2003

(54) Information processing device

(76) Inventor: Shuzo Fujioka, Hyogo (JP)

Correspondence Address: BURNS DOANE SWECKER & MATHIS L L P, POST OFFICE BOX 1404, ALEXANDRIA, VA, 22313-1404, US

(21) Appl. No.: 10/166,269

(22) Filed: Jun. 11, 2002

(30) Foreign Application Priority Data
Jun. 28, 2001 (JP) 2001-197058

(51) Int. Cl. G06F 12/14

(52) U.S. Cl. 713/193

(57) ABSTRACT

An information processing device is provided with a storage unit for storing key data used to perform encryption processing for data security as well as inversion of the key data, and an encryption processing unit for reading the key data together with the inversion of the key data from the storage unit, and for performing the encryption processing by using the key data read out of the storage unit.

### BACKGROUND OF THE INVENTION

1. Field of the Invention

The present invention relates to an information processing device of contact type, such as a contact IC card, connected to a reader by way of a cable (connector) and an information processing device of contactless type, such as a contactless IC card, connected to a reader by radio. Particularly, it relates to an information processing device having a security function for data security.

2. Description of Related Art

With the recently-increasing use of data communications, falsification and illegal use of data through the interception of the data being communicated increase. To retain the security of data against such misbehavior, prior art information processing devices have an encryption function. In other words, prior art information processing devices encrypt data to be transmitted by using key data, and decrypt received data by using the key data used for the encryption. In a prior art information processing device having such an encryption function, key data is stored in a nonvolatile memory, and the key data is read out of the nonvolatile memory and data to be transmitted is encrypted according to a sequence of operations as shown in FIG. 21.

In other words, the prior art information processing device, in step ST1 of FIG. 21, performs operations by using the key data based on an arithmetic computation program A. The prior art information processing device then, in step ST2, performs operations by using the same key data based on an arithmetic computation program B. By using execution results obtained by the execution of the arithmetic computation programs A and B using the same key data, the prior art information processing device further, in step ST3, performs operations according to another arithmetic computation program C. Thus any person, who does not know the key data, cannot intercept encrypted data obtained by the execution of the arithmetic computation programs according to the procedure.

However, any person who gets the key data can easily intercept the processed, i.e., encrypted data. For example, the key data can be estimated by physically taking the IC chip of the information processing device out of the package and then performing a failure analysis on the IC chip, analyzing timing such as the timing at which the arithmetic computation programs associated with the encryption processing are executed, or monitoring and analyzing the power consumption in the IC chip. Particularly, the power analysis through which the key data can be analyzed based on changes in the power consumption in the IC chip is a threat. When the prior art information processing device reads the key data stored in the nonvolatile memory, the power consumption in the IC chip varies with time according to whether each bit of the key data is “1” or “0”.

Thus, because the power consumption in the IC chip changes depending on the value of the key data when reading the key data for the encryption of data to be transmitted or when an encryption circuit operates, the key data can be estimated with relative ease. Particularly, when processing data according to the sequence of operations as shown in FIG. 21, since the arithmetic computation program A and the arithmetic computation program B are always executed in the same order, changes in the power consumption can appear clearly and it is therefore easy to analyze the key data.

The power analysis is a well-known technique, for example, as disclosed in “III.3.3 power analysis” of “Report of the investigation about the safety of smart cards in 1999”, and therefore the explanation of the power analysis will be omitted hereafter.

Furthermore, in the case of a contactless IC card, since the contactless IC card receives a supply of electric power by radio, changes in the power consumption due to internal operations can easily appear on a power wire (Vcc line). Furthermore, since the contactless IC card uses the AM modulation (ASK modulation) and generates a power supply from a modulated wave at the same time, the modulated wave can also appear on the Vcc line. Therefore, no data is sent and received by such a prior art contactless IC card while encryption is carried out.

Japanese patent application publications No. 2000-259799, No. 2000-165375, No.2000-78666, No. 11-338347, and No. 6-4407 disclose such prior art information processing devices.

A problem with prior art information processing devices constructed as above is that because the power consumption in the information processing device changes depending on the value of key data when reading the key data for encryption of data to be transmitted or when an encryption circuit operates, the key data can be estimated with relative ease and therefore any person, who does not know the key data, can intercept encrypted data by analyzing the key data. Particularly, in the case of a contactless IC card, another problem is that since the contactless IC card generates a power supply from a modulated wave at the same time, the modulated wave can also appear on a Vcc line and therefore the key data can be estimated easily.

### SUMMARY OF THE INVENTION

The present invention is proposed to solve the above-mentioned problems, and it is therefore an object of the present invention to provide an information processing device in which when reading key data for encryption of data to be transmitted or when an encryption circuit operates, the power consumption in the information processing device does not vary with time depending on the value of the key data, thereby making it difficult for any person who does not know the key data to estimate the key data and hence to intercept encrypted data.

In accordance with an aspect of the present invention, there is provided an information processing device including an encryption processing circuit for reading key data together with the inversion of the key data from a storage circuit, and for performing encryption processing by using the key data read out of the storage circuit. Consequently, since when reading the key data the inversion of the key data is also read out of the storage circuit, the number of 0s and the number of 1s included in the key data and the inversion of the key data read from the storage circuit become equal to each other. In other words, when reading the key data for encryption of data to be transmitted, the power consumption in the information processing device does not vary with time depending on the value of the key data, but becomes constant during the interval that the key data is being read from the storage circuit. The aspect of the present invention therefore offers an advantage of making it difficult for any person who does not know the key data to estimate the key data through power analysis and hence to intercept encrypted data, thereby providing a high level of security.

In accordance with a further aspect of the present invention, there is provided an information processing device including a random number generation circuit for generating a random number, and an encryption processing circuit for reading key data from a storage circuit and for performing encryption processing by using the key data read out of the storage circuit while changing a order in which two or more arithmetic computations associated with the encryption processing are performed according to the random number generated by the random number generation circuit. Consequently, since every time the information processing device performs the encryption processing, the information processing device can change the order in which the two or more arithmetic computations are performed according to the random number, the present aspect offers an advantage of making it difficult for any person who does not know the key data to estimate the key data through power analysis and hence to intercept encrypted data.

In accordance with another aspect of the present invention, there is provided an information processing device including a random number generation circuit for generating a random number, and an encryption processing circuit for reading key data from a storage circuit and for performing encryption processing by using the key data read out of the storage circuit while changing timing at which two or more arithmetic computations associated with the encryption processing are performed according to the random number generated by the random number generation circuit. Consequently, since every time the information processing device performs the encryption processing, the information processing device can change the timing at which the two or more arithmetic computations are performed according to the random number, the present aspect offers an advantage of making it difficult for any person who does not know the key data to estimate the key data through power analysis and hence to intercept encrypted data.

In accordance with a further aspect of the present invention, there is provided an information processing device including a random number generation circuit for generating a random number, and an encryption processing circuit for sequentially reading a plurality of parts of key data one after another from a storage circuit while determining a part of the key data to be read for the next time according to the random number generated by the random number generation circuit, and for performing encryption processing by using the key data read out of the storage circuit. Consequently, since the information processing device can change the order in which all the parts of the key data are read on a one-by-one basis according to the generated random number, the present aspect offers an advantage of making it difficult for any person to estimate the key data and hence to intercept encrypted data even though he or she gets the value of each part of the key data because he or she cannot get the order in which all the parts of the key data have been read on a one-by-one basis.

In accordance with another aspect of the present invention, there is provided an information processing device including an encryption processing circuit for reading key data from a storage circuit and for performing encryption processing by using the key data read out of the storage circuit, an arithmetic computation circuit for performing specific arithmetic computations associated with the encryption processing performed by the encryption processing circuit, a first clock generation circuit for supplying a clock to the arithmetic computation circuit, and a second clock generation circuit for supplying another clock different from the clock generated by the first clock generation circuit to the encryption processing circuit. Consequently, the present aspect offers an advantage of making it difficult to analyze the operating electric power consumed within the information processing device and therefore making it more difficult for any person to estimate the key data.

In accordance with another aspect of the present invention, there is provided an information processing device that sends and receives data to and from a reader, the device including an encryption processing circuit for reading key data from a storage circuit and for performing encryption processing by using the key data read out of the storage circuit, and a transmission circuit for transmitting a random number generated by a random number generation circuit to the reader while the encryption processing circuit performs the encryption processing by using the key data. Consequently, since the contactless information processing device can cause a random noise in a power supply line, the present aspect offers an advantage of making it more difficult to estimate the key data through power analysis.

In accordance with another aspect of the present invention, there is provided an information processing device including an encryption processing circuit for reading the key data from the storage circuit and for performing the encryption processing by using the key data read out of the storage circuit, and a noise superimposing circuit for superimposing a noise on a power supply line according to a random number generated by a random number generation circuit. Consequently, since the information processing device can superimpose the noise whose level changes at random according to the random number on the power supply line and hence can change the power consumption, the present aspect offers an advantage of making it difficult to estimate the key data through power analysis.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of an information processing device according to a first embodiment of the present invention;

FIG. 2A is a diagram showing a 1-word part of key data used for arithmetic computations associated with encryption processing which are performed by an encryption circuit of the information processing device according to the first embodiment;

FIG. 2B is a diagram showing storage of the 1-word part of the key data in an E2PROM of the information processing device according to the first embodiment;

FIG. 3A is a schematic circuit diagram showing the structure of an example of each 1-word unit of a read circuit for use in the E2PROM;

FIG. 3B is a diagram showing an operation of each 1-bit part of each 1-word unit of the read circuit when reading a bit of the key data set to “1”;

FIG. 3C is a diagram showing an operation of each 1-bit part of each 1-word unit of the read circuit when reading a bit of the key data set to “0”;

FIG. 4 is a block diagram showing the structure of an information processing device according to a second embodiment of the present invention;

FIG. 5 is a flow chart showing the operation of the information processing device according to the second embodiment;

FIG. 6 is a flow chart showing the operation of an information processing device according to a third embodiment of the present invention;

FIG. 7A is a drawing showing an example of generation of dummy key data according to the third embodiment;

FIG. 7B is a drawing showing another example of generation of dummy key data according to the third embodiment;

FIG. 8 is a drawing showing setting of key data to an encryption circuit of an information processing device according to a fourth embodiment of the present invention;

FIG. 9 is a flow chart showing the setting of the key data to the encryption circuit of the information processing device according to the fourth embodiment;

FIG. 10 is a block diagram showing a supply of clocks to an encryption circuit and a CPU of an information processing device according to a fifth embodiment of the present invention;

FIG. 11 is a block diagram showing selection of two clocks as the clocks supplied to the encryption circuit and the CPU according to a variant of the fifth embodiment;

FIG. 12 is a drawing showing the structure of an example of a first clock circuit for use in an information processing device according to a sixth embodiment of the present invention;

FIG. 13 is a drawing showing the structure of another example of the first clock circuit for use in the information processing device according to the sixth embodiment of the present invention;

FIG. 14 is a block diagram showing the structure of a contactless information processing device according to a seventh embodiment of the present invention;

FIG. 15 is a timing chart showing data transfer between the contactless information processing device according to the seventh embodiment of the present invention and a reader;

FIG. 16 is a drawing showing the structure of a response frame which is transmitted to the reader by the contactless information processing device according to the seventh embodiment;

FIG. 17 is a block diagram showing an example of a noise generation circuit for use in an information processing device according to an eighth embodiment of the present invention;

FIG. 18 is a block diagram showing another example of the noise generation circuit of the information processing device according to the eighth embodiment;

FIG. 19 is a block diagram showing the structure of an encryption circuit for use in an information processing device according to a ninth embodiment of the present invention;

FIG. 20 is a schematic circuit diagram showing a pair of lines via which data and inversion of the data are transmitted in the encryption circuit for use in the information processing device according to the ninth embodiment; and

FIG. 21 is a flow chart showing the operation of a prior art information processing device.

### DETAILED DESCRIPTION OF THE PREFERRED EMBODIMENTS

### Embodiment 1

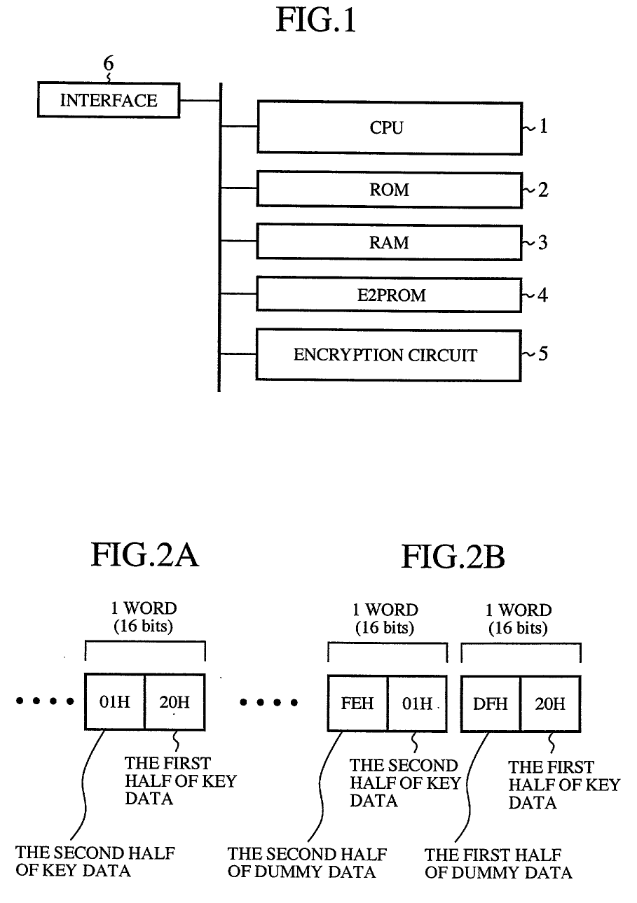

FIG. 1 is a block diagram showing an information processing device according to a first embodiment of the present invention, which can be a contact integrated circuit (or IC) card having a built-in security function. In the figure, reference numeral 1 denotes a CPU for controlling the whole of the microcomputer, such as a contact IC card or the like, and for executing an encryption processing program, reference numeral 2 denotes a ROM for storing the encryption processing program to be executed by the CPU 1, reference numeral 3 denotes a RAM in which data to be processed by the CPU 1 is written, reference numeral 4 denotes a nonvolatile memory (E2PROM) disposed for holding key data for data security, reference numeral 5 denotes an encryption circuit for performing specific arithmetic computations associated with the encryption processing by using the key data stored in the nonvolatile memory 4, reference numeral 6 denotes an interface between input data input to the contact IC card and output data output from the contact IC card. The CPU 1, the ROM 2, the RAM 3, the E2PROM 4, the encryption circuit 5, and the interface 6 are connected to one another by way of a bus.

FIG. 2A shows a 1-word part of the key data used in arithmetic computations associated with the encryption processing which are performed by the encryption circuit 5, and FIG. 2B shows storage of the part of the key data in the E2PROM 4. In FIGS. 2A and 2B, one word (a data unit in which the CPU 1 reads the key data from the E2PROM 4) is 16-bit data. As shown in FIG. 2B, the first half of ½ words of the part of the key data as shown in FIG. 2A and dummy data which is the inversion of the first half of the part of the key data are stored in a word of the E2PROM 4, and the second half of ½ words of the part of the key data as shown in FIG. 2A and the dummy data which is the inversion of the second half of the part of the key data are stored in another word adjacent to the word of the E2PROM 4 in which the first half of ½ words of the part of the key data and the first half of the corresponding dummy data are stored. Thus, part of the key data and corresponding part of the dummy data are stored in groups of 8 bits in each word (16 bits) of the E2PROM 4.

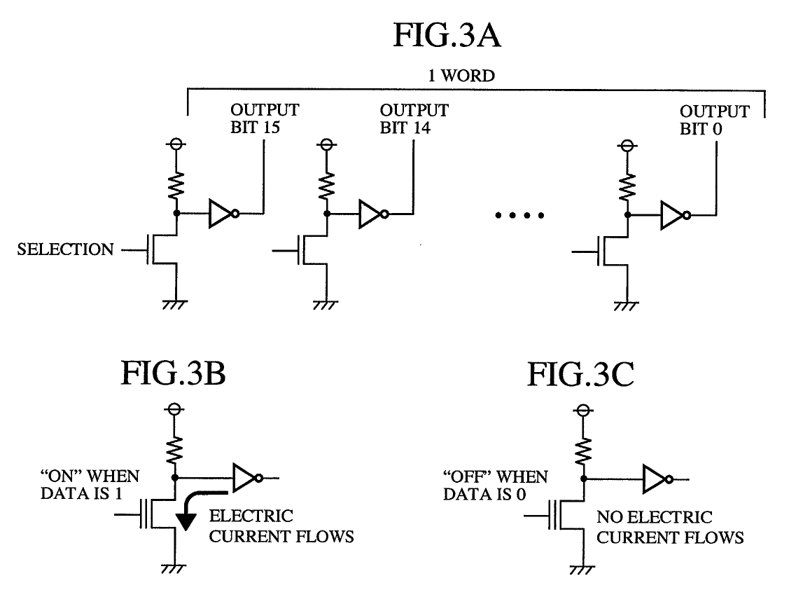

One half of each 1-word part of the key data and a corresponding part of the dummy data which is the inversion of the one half of each part of the key word are read from each word of the E2PROM 4, and they are sent to the encryption circuit 5. The encryption circuit 5 then performs arithmetic computations associated with the encryption processing using the key data. FIG. 3A is a schematic circuit diagram showing the structure of an example of each 1-word unit of a read circuit for use in the E2PROM 4, FIG. 3B shows an operation of each 1-bit part of each 1-word unit of the read circuit when reading a bit of the key data set to “1”, and FIG. 3C shows an operation of each 1-bit part of each 1-word unit of the read circuit when reading a bit of the key data set to “0”. In other words, an electric current flows to a 1-bit storage element as shown in FIG. 3B when binary data “1” is input to a selection terminal, whereas no electric current flows to the storage element as shown in FIG. 3C when binary data “0” is input to the selection terminal. When one half of each 1-word part of the key data and one half of a corresponding part of the dummy data which is the inversion of the one half of each part of the key word are read from each word of the E2PROM 4, the number of 1s and the number of 0s included in them read out of the E2PROM 4 are both 8. In other words, the number of 0s and the number of 1s included in one half of each part of the key data and one half of a corresponding part of the dummy data read from the E2PROM 4 are equal. Therefore, when the key data is read out of the E2PROM in word units, the number of bits in each word of the key data which cause an electric current to flow through the read circuit becomes equal to the number of bits in each word of the key data which do not cause an electric current to flow through the read circuit, and hence the power consumption becomes constant during the interval that the key data is being read from the E2PROM.

Thus, since the information processing device according to the first embodiment of the present invention simply writes dummy data each bit of which is the inversion of a corresponding bit of the key data in the E2PROM 4 as well as the key data, and reads one half of each word of the key data and one half of a corresponding word of the dummy data which is the inversion of the one half of each word of the key word from each word of the E2PROM 4 in which the key word and the dummy data are stored when performing the encryption processing using the key data, the information processing device according to the first embodiment of the present invention can use the architecture of the E2PROM for use in prior art information processing devices without changing the architecture of the E2PROM.

As mentioned above, in accordance with the first embodiment of the present invention, since the information processing device writes dummy data each bit of which is the inversion of a corresponding bit of the key data in the E2PROM 4 as well as the key data, the number of 0s and the number of 1s included in one half of each word of the key data and one half of a corresponding part of the dummy data read from the E2PROM 4 become equal to each other when reading the key data from the E2PROM 4. Consequently, when reading the key data for encryption of data to be transmitted or when the encryption circuit operates, the power consumption in the information processing device does not vary with time depending on the value of the key data, but becomes constant during the interval that the key data is being read from the E2PROM.

### Embodiment 2

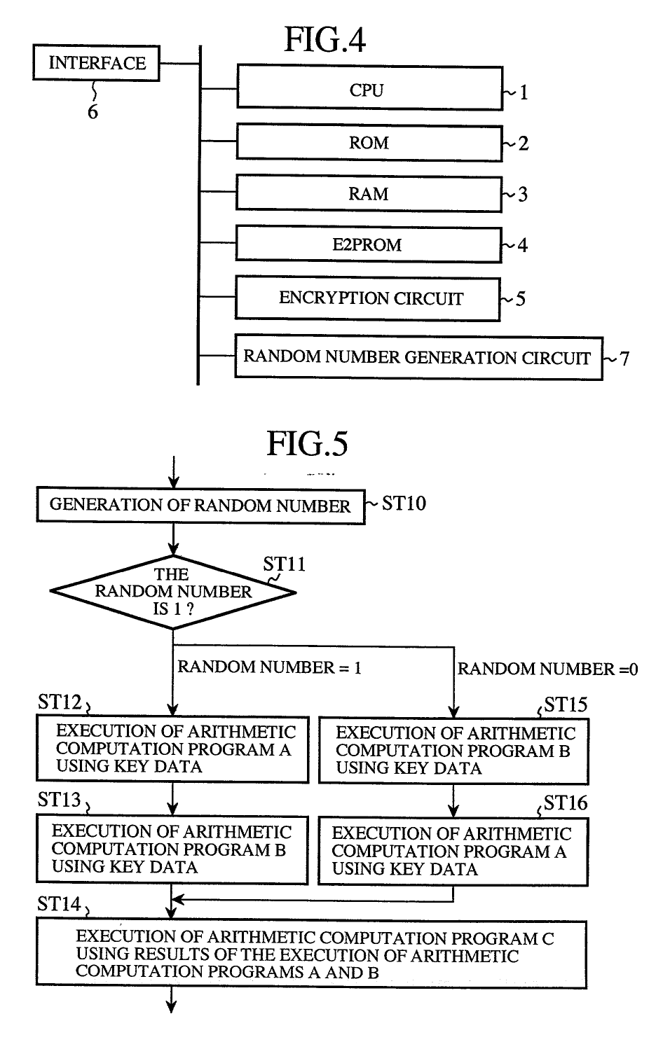

FIG. 4 is a block diagram showing an information processing device according to a second embodiment of the present invention. A contact IC card having a built-in security function is illustrated as an example of the information processing device in FIG. 4. In the figure, reference numeral 1 denotes a CPU, reference numeral 2 denotes a ROM, reference numeral 3 denotes a RAM, reference numeral 4 denotes an E2PROM, reference numeral 5 denotes an encryption circuit, and reference numeral 6 denotes an interface. These components correspond to those shown in FIG. 1 which are designated by the same reference numerals and therefore the detailed explanation of those components will be omitted hereafter. Furthermore, reference numeral 7 denotes a random number generation circuit for generating a random number before the encryption circuit 5 performs arithmetic computations associated with encryption processing.

FIG. 5 is a flow chart showing the operation of the information processing device according to the second embodiment of the present invention. First, the CPU 1, in step ST10, generates a random number “1” or “0” by means of the random number generation circuit 7 before executing an encryption processing program containing arithmetic computation programs A, B, and C, as shown in FIG. 5. The CPU 1 then, in step ST11, determines whether the generated random number is “1” or “0”. If the generated random number is “1”, the CPU 1 advances to step ST12 wherein it performs arithmetic computations based on the arithmetic computation program A by using key data stored in the E2PROM 4 by means of the encryption circuit 5. The CPU 1 then, in step ST13, performs arithmetic computations based on the arithmetic computation program B by using the key data by means of the encryption circuit 5. The CPU1 further, in step ST14, performs arithmetic computations based on the arithmetic computation program C by using execution results obtained by the sequential execution of the arithmetic computation programs A and B using the same key data by means of the encryption circuit 5.

In contrast, if it is determined in step ST11 that the random number generated by the random number generation circuit 7 is “0”, the CPU 1 advances to step ST15 wherein it performs arithmetic computations based on the arithmetic computation program B by using the key data stored in the E2PROM 4 by means of the encryption circuit 5. The CPU 1 then, in step ST16, performs arithmetic computations based on the arithmetic computation program A by using the key data by means of the encryption circuit 5. The CPU1 further, in step ST14, performs arithmetic computations based on the arithmetic computation program C by using execution results obtained by the sequential execution of the arithmetic computation programs B and A using the same key data by means of the encryption circuit 5. In this case, because the arithmetic computation program C uses the computation results from the arithmetic computation programs A and B, the arithmetic computation program C cannot perform arithmetic computations prior to the execution of the arithmetic computation programs A and B. In other words, as long as the execution of the arithmetic computation programs A and B is completed, the CPU can perform the encryption processing properly even if the sequence of the execution of the arithmetic computation programs A and B is changed.

In the second embodiment of the present invention, every time the CPU 1 starts the execution of the encryption processing program, the CPU 1 thus generates a random number by means of the random number generation circuit 7 and changes the order in which the arithmetic computation programs A and B are executed according to the random number. Therefore, even if any person tries to monitor a Vcc line disposed as power supply wire many times so as to estimate the key data through power analysis, he or she will understand that it is difficult to perform the power analysis because the sequence of the execution of the arithmetic computation programs A and B is changed and hence the power consumption changes every time the Vcc line is monitored.

Another encryption circuit disposed independently of the encryption circuit 5 can perform arithmetic computations concurrently while the CPU 1 is executing an arithmetic computation program. For example, the other encryption circuit can perform an encryption operation using dummy public-key data concurrently while the encryption circuit 5 performs an encryption operation using common-key data. The other encryption circuit can also perform an encryption operation using dummy common-key data concurrently while the encryption circuit 5 performs an encryption operation using public-key data. In general, an LSI (information processing device) having a security function has both the encryption circuits.

As mentioned above, in accordance with the second embodiment of the present invention, every time the information processing device executes the encryption processing program the information processing device generates a random number and changes the order in which the arithmetic computation programs A and B are executed according to the random number. Consequently, the second embodiment offers an advantage of making it difficult for any person who does not know the key data to estimate the key data through power analysis so as to intercept encrypted data.

### Embodiment 3

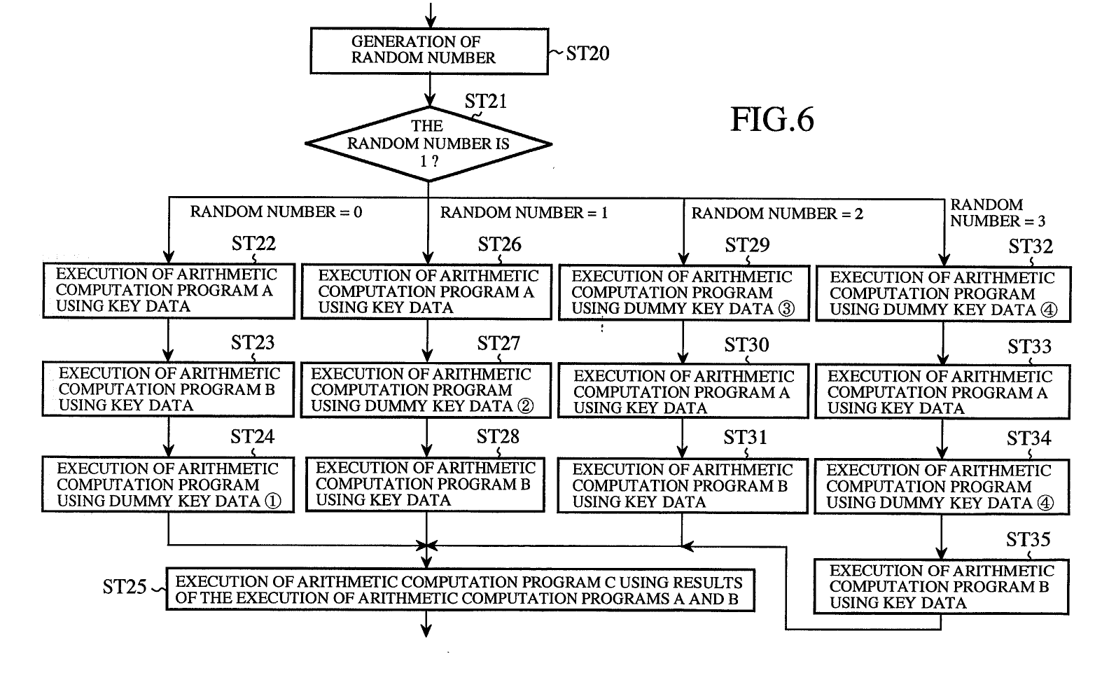

FIG. 6 is a flow chart showing the operation of an information processing device according to a third embodiment of the present invention. Although the information processing device according to the third embodiment includes a structure similar to that of the information processing device according to the second embodiment as shown in FIG. 4, the information processing device according to the third embodiment differs from that of the above-mentioned second embodiment in that a random number generation circuit 7 generates a random number having an integer value ranging from “0” to “3”, a CPU 1 changes the timing at which it executes arithmetic computation programs A and B by using true key data stored in an E2PROM 4 according to the random number generated by the random number generation circuit 7, and the E2PROM 4 holds a plurality of dummy key data as well as the key data.

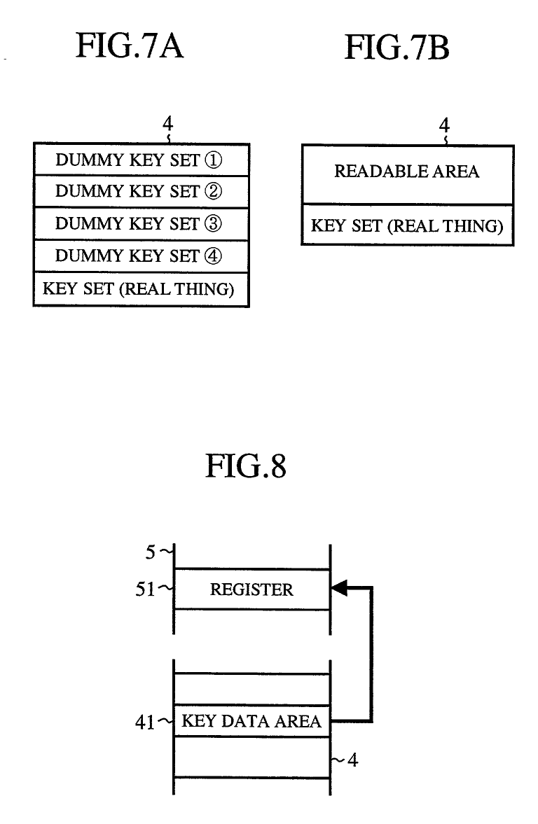

In operation, the CPU 1, in step ST20, generates a random number having an integer value ranging from “0” to “3” by means of the random number generation circuit 7. FIGS. 7A and 7B are drawings for showing two methods of generating one dummy key data according to the random number having an integer value ranging from “0” to “3”, respectively. One of the two methods comprises the step of selecting a dummy key set from among four dummy key sets \hat{1} to \hat{4} which correspond to the four integer values “0” to “3”, respectively, and which are stored in the E2PROM 4, as shown in FIG. 7A, according to the random number generated by the random number generation circuit 7. Furthermore, the other method, as shown in FIG. 7B, comprises the steps of storing a data string in a readable area of the E2PROM 4, generating a starting address of data to be read out of the E2PROM 4 using the random number generated by the random number generation circuit 7, reading a necessary amount of data from a location of the E2PROM 4 specified by the starting address, and using the read data as the dummy key data.

The CPU 1 then, in step ST21, determines if the generated random number is “0”, “1”, “2”, or “3”. If the random number generated by the random number generation circuit 7 is “0”, the CPU 1 advances to step ST22 in which it performs arithmetic computations based on the arithmetic computation program A by using the true key data stored in the E2PROM 4 by means of an encryption circuit 5. The CPU 1 then, in step ST23, performs arithmetic computations based on the arithmetic computation program B by using the same key data by means of the encryption circuit 5. After that, the CPU 1 advances to step ST24 in which it selects the first dummy key set \hat{1} corresponding to the random number “0” from the E2PROM 4 and performs arithmetic computations based on a dummy arithmetic computation program by using the dummy key set \hat{1} by means of the encryption circuit 5. The CPU 1 then, in step ST25, performs arithmetic computations based on an arithmetic computation program C by using execution results obtained from the sequential execution of the arithmetic computation programs A and B using the true key data by means of the encryption circuit 5.

If the random number generated by the random number generation circuit 7 is “1”, the CPU 1 advances to step ST26 in which it performs arithmetic computations based on the arithmetic computation program A by using the true key data stored in the E2PROM 4 by means of the encryption circuit 5. Next, the CPU 1, in step ST27, selects the second dummy key set \hat{2} corresponding to the random number “1” from the E2PROM 4 and performs arithmetic computations based on the dummy arithmetic computation program by using the dummy key set \hat{2} by means of the encryption circuit 5. The CPU 1 then advances to step ST28 in which it performs arithmetic computations based on the arithmetic computation program B by using the true key data stored in the E2PROM 4. The CPU 1 further, in step ST25, performs arithmetic computations based on the arithmetic computation program C by using execution results obtained from the sequential execution of the arithmetic computation programs A and B using the true key data by means of the encryption circuit 5. In this case, as compared with the case of the random number=0, the time at which the arithmetic computation program B is executed is changed by the execution in step ST27 of the dummy arithmetic computation program using the second dummy key data.

If the random number generated by the random number generation circuit 7 is “2”, the CPU 1 advances to step ST29 in which it selects the third dummy key set \hat{3} corresponding to the random number “2” from the E2PROM 4 and performs arithmetic computations based on the dummy arithmetic computation program by using the dummy key set \hat{3} by means of the encryption circuit 5. The CPU 1 then, in step ST30, performs arithmetic computations based on the arithmetic computation program A by using the true key data stored in the E2PROM 4 by means of the encryption circuit 5. After that, the CPU 1 advances to step ST31 in which it performs arithmetic computations based on the arithmetic computation program B by using the true key data stored in the E2PROM 4 by means of the encryption circuit 5. The CPU 1 further, in step ST25, performs arithmetic computations based on the arithmetic computation program C by using execution results obtained from the sequential execution of the arithmetic computation programs A and B using the true key data by means of the encryption circuit 5. In this case, as compared with the case of the random number=0, the timing at which the arithmetic computation programs A and B are executed are changed by the execution in step ST29 of the dummy arithmetic computation program using the third dummy key data.

If the random number generated by the random number generation circuit 7 is “3”, the CPU 1 advances to step ST32 in which it selects the fourth dummy key set \hat{4} corresponding to the random number “3” from the E2PROM 4 and performs arithmetic computations based on the dummy arithmetic computation program by using the dummy key set \hat{4} by means of the encryption circuit 5. The CPU 1 then, in step ST33, performs arithmetic computations based on the arithmetic computation program A by using the true key data stored in the E2PROM 4 by means of the encryption circuit 5. After that, the CPU 1, in step ST34, performs arithmetic computations based on the dummy arithmetic computation program by using the fourth dummy key set \hat{4} stored in the E2PROM 4 by means of the encryption circuit 5. The CPU 1 then advances to step ST35 in which it performs arithmetic computations based on the arithmetic computation program B by using the true key data stored in the E2PROM 4 by means of the encryption circuit 5. The CPU 1 further, in step ST25, performs arithmetic computations based on the arithmetic computation program C by using execution results obtained from the sequential execution of the arithmetic computation programs A and B using the true key data by means of the encryption circuit 5. In this case, as compared with the case of the random number=0, the timing at which the arithmetic computation programs A and B are executed are changed by the execution in steps ST32 and ST34 of the dummy arithmetic computation program using the fourth dummy key data.

Even in the third embodiment of the present invention, another encryption circuit disposed independently of the encryption circuit 5 performs encryption processing concurrently while the CPU 1 is executing one arithmetic computation program. For example, the other encryption circuit can perform an encryption operation using dummy public-key data concurrently while the encryption circuit 5 performs an encryption operation using common-key data. The other encryption circuit can also perform an encryption operation using dummy common-key data concurrently while the encryption circuit 5 performs an encryption operation using public-key data. In general, an LSI (information processing device) having a security function has both the encryption processing circuits.

As mentioned above, in accordance with the third embodiment of the present invention, since every time the CPU performs the encryption processing, the timing at which the arithmetic computation programs A and B are executed and power consumption may be monitored can be changed according to the generated random number, the third embodiment offers an advantage of making it difficult for any person who does not know the key data to perform power analysis so as to intercept encrypted data.

### Embodiment 4

FIG. 8 is a drawing showing setting of key data to an encryption circuit of an information processing device according to a fourth embodiment of the present invention. In the figure, reference numeral 41 denotes a key data area of an E2PROM 4 in which the key data used for encryption processing is stored, and reference numeral 51 denotes a register to which the key data stored in the key data area 41 is set from the E2PROM 4. The encryption circuit 5 performs arithmetic computations associated with the encryption processing based on an arithmetic computation program by using the key data set to the register 51.

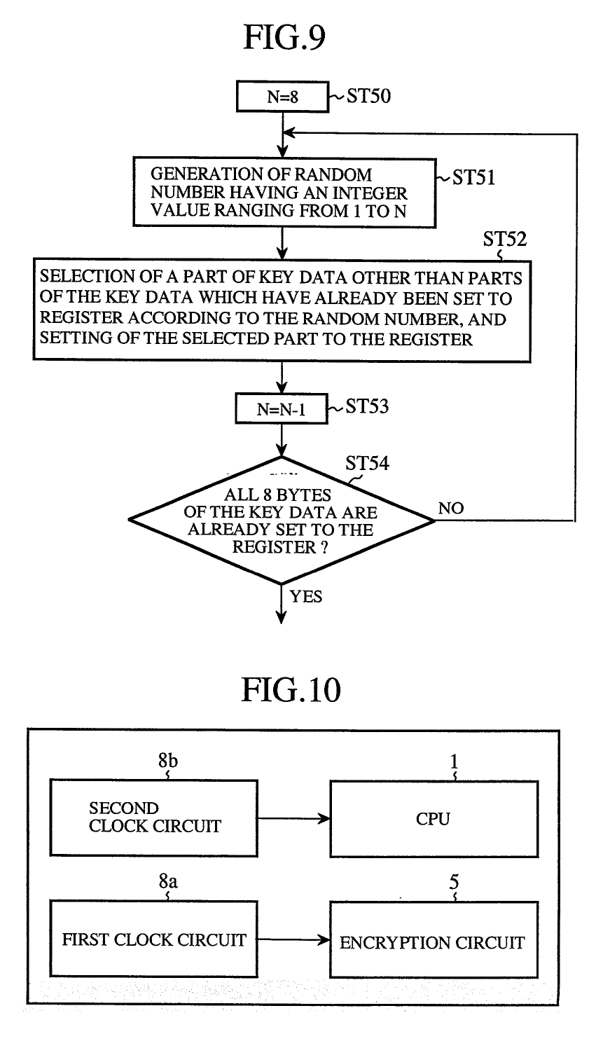

It is necessary to set the key data from the E2PROM 4 to the register 51 of the encryption circuit 5 before the encryption circuit 5 performs arithmetic computations associated with the encryption processing. In this case, if a plurality of bytes of the key data are read on a byte-by-byte basis from the E2PROM 4 in the same order every time the key data is set to the register 51, the key data can be easily estimated. Therefore, the information processing device according to the fourth embodiment of the present invention changes the order in which the plurality of bytes of the key data are read on a byte-by-byte basis from the E2PROM 4 every time the key data is set to the register 51, thereby making it difficult to estimate the key data. FIG. 9 is a flow chart showing a procedure of changing the order in which the plurality of bytes of the key data are read on a byte-by-byte basis from the E2PROM 4 every time the key data is set to the register 51 of the encryption circuit 5 in the case that the key data is 8-byte data.

First, a counter for counting the number of bytes of the key data is set at N=8 in step ST50. The CPU then advances to step ST51 in which it generates a random number having an integer value ranging from 1 to 8 by means of a random number generation circuit 7. The CPU then, in step ST52, reads 1 byte of the key data corresponding to the random number generated by the random number generation circuit 7 from the key data area 41 of the E2PROM 4, and sets the byte to the register 51 of the encryption circuit 5. In this case, the CPU selects 1 byte of the key data other than one or more bytes of the key data, which have already been set to the register 51, according to the random number, and sets the selected 1 byte of the key data to the register 51 of the encryption circuit 5. Then the count value of the counter is decremented by one in step ST53, and the above-mentioned processes are repeated in step ST54 until the setting of all the 8 bytes of the key data to the register is completed.

As mentioned above, in accordance with the fourth embodiment of the present invention, the order in which all the bytes of the key data are read on a byte-by-byte basis is changed according to the generated random number. The fourth embodiment offers an advantage of making it difficult for any person to estimate the key data so as to intercept encrypted data even though he or she gets the value of each byte of the key data because he or she cannot get the order in which all the bytes of the key data have been read on a byte-by-byte basis.

### Embodiment 5

FIG. 10 is a block diagram showing a supply of clocks in an information processing device according to a fifth embodiment of the present invention. In the figure, reference numeral 8a denotes a first clock circuit for supplying a clock to an encryption circuit 5, and reference numeral 8b denotes a second clock circuit for supplying another clock different from the clock output from the first clock circuit 8a to a CPU 1.

If the CPU 1 and the encryption circuit 5 are made to operate from an identical clock from the same clock circuit, changes in the power consumption can appear clearly. Even if two clocks of different frequencies are generated from a clock generated by the same clock circuit by using a frequency divider and the CPU 1 and the encryption circuit 5 are made to operate from the two clocks of different frequencies, respectively, changes in the power consumption can appear clearly because those clocks are synchronized with each other. In contrast, in accordance with the fifth embodiment of the present invention, different clocks are supplied from the two clock circuits 8a and 8b disposed independently of each other to the CPU 1 and the encryption circuit 5, as shown in FIG. 10. Thus, noise caused by the operating electric power supplied to the CPU 1 and the encryption circuit 5 asynchronously occurs on a Vcc line by supplying the first clock from the first clock circuit 8a to the encryption circuit 5, and supplying the second clock from the second clock circuit 8b to the CPU 1. Therefore, it becomes difficult to analyze the operating electric power consumed within the information processing device based on the Vcc line, thereby making it more difficult for any person to estimate the key data.

Furthermore, while it is preferable that the second clock supplied to the CPU 1 should not depend on the temperature and operating voltage, the use of a clock having a temperature characteristic and a voltage characteristic as the second clock supplied to the encryption circuit 5 makes it more difficult to analyze the operating electric power from the Vcc line.

When the information processing device is a contactless IC card, an oscillation circuit, such as a VCO whose oscillation frequency can change according to an input voltage, can be used for the clock generation because the operating voltage becomes unstable in the contactless IC card.

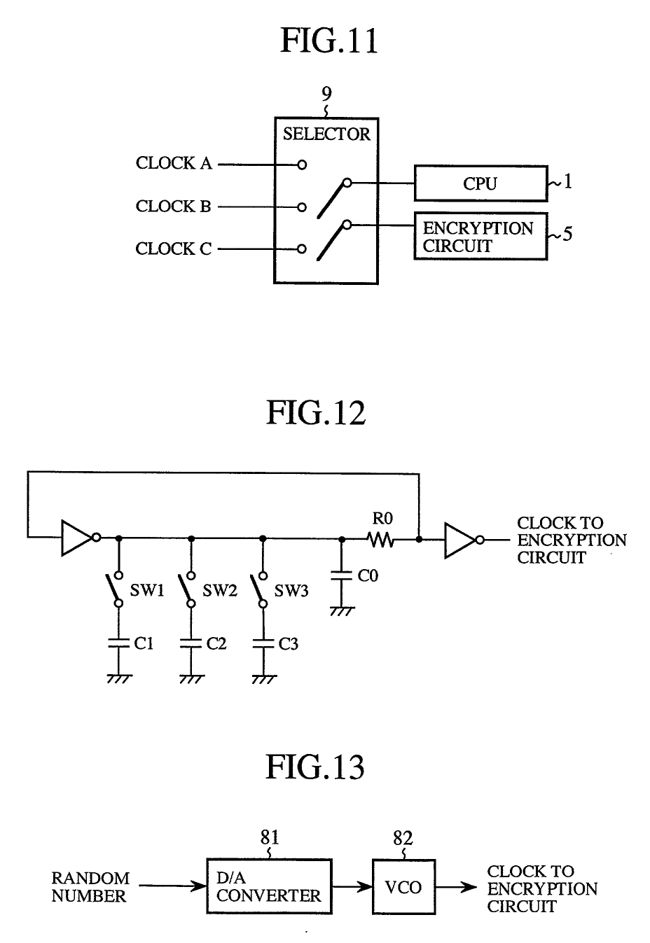

A variant of the fifth embodiment has a mechanism, as shown in FIG. 11, of selecting two clocks, as the first and second clocks respectively supplied to the CPU 1 and the encryption circuit 5, from among a plurality of clocks by means of a selector 9. The variant controls the selector 9 by generating a random number before the encryption circuit 5 performs arithmetic computations associated with the encryption processing so as to select two clocks as the first and second clocks to be respectively supplied to the CPU 1 and the encryption circuit 5, and returns to its original state in which two clocks previously supplied to the CPU 1 and the encryption circuit 5 before the performance of the encryption processing are respectively supplied to them.

As mentioned above, in accordance with the fifth embodiment of the present invention, the information processing device can supply different clocks from the two clock circuits 8a and 8b disposed independently of each other to the CPU 1 and the encryption circuit 5, respectively, thereby making it difficult to analyze the operating electric power consumed within the information processing device and therefore making it more difficult for any person to estimate the key data.

### Embodiment 6

FIG. 12 is a drawing showing the structure of an example of a first clock circuit 8a, as shown in FIG. 10, for use in an information processing device according to a sixth embodiment of the present invention. The clock circuit as shown in FIG. 12 uses an oscillation circuit. In the figure, R0 and C0 denote a resistor and a capacitor that determine the fundamental frequency of the oscillation circuit, respectively, C1 to C3 denote capacitors used for changing the oscillation frequency, and SW1 to SW3 denote switches that are turned on or off according to a random number applied thereto so as to connect or disconnect the capacitors C1 to C3 to or from the oscillation circuit. These capacitors C1 to C3 may have different capacities, or may have an identical capacity.

In operation, the switches SW1 to SW3 are controlled by a 3-bit random number generated by a random number generation circuit 7 as shown in FIG. 4. In other words, if the random number is “000”, all the switches SW1 to SW3 are turned off. If the random number is “001”, only the switch SW1 is turned on. If the random number is “010”, only the switch SW2 is turned on. If the random number is “011”, only the switches SW1 and SW2 are turned on. If the random number is “100”, only the switch SW3 is turned on. If the random number is “101”, only the switches SW1 and SW3 are turned on, . . . , and if the random number is “111”, all the switches SW1 to SW3 are turned on. Therefore, when the random number is “000”, the oscillation frequency of the oscillation circuit becomes its maximum value (fundamental frequency). Therefore, when one or more of the capacitors C1 to C3 are selectively connected in parallel to the capacitor C0 according to the generated random number, the oscillation frequency decreases according to which one or more of the capacitors C1 to C3 are connected in parallel. When the random number is “111”, the oscillation frequency becomes its minimum value. Thus, the clock to be supplied to an encryption circuit 5 is generated based on the oscillation frequency of the oscillation circuit that can vary according to the random number.

Another example of the first clock circuit 8a including a combination of a DAC and a VCO is shown in FIG. 13. In the figure, reference numeral 81 denotes the DAC for converting a random number generated by the random number generation circuit 7 as shown in FIG. 4 into an equivalent analog value, and reference numeral 82 denotes the VCO whose oscillation frequency is controlled by the analog value output from the DAC 81.

In operation, a random number in the form of a digital signal generated by the random number generation circuit 7 is input to the DAC 81. When the DAC 81 receives the random number in the form of a digital signal, it converts the random number into an equivalent analog value and then sends the analog value to the VCO 82. The VCO 82 is controlled by the analog voltage and oscillates at a frequency corresponding to the random number. Thus, the clock to be supplied to the encryption circuit 5 is generated based on the oscillation frequency of the oscillation circuit which can vary according to the random number.

The encryption circuit 5 changes in its operating electric power as the operation frequency of the clock supplied from the first clock circuit 8a changes. Thus, if the encryption circuit 5 changes in its operating electric power according to the random number every time the encryption circuit 5 performs arithmetic computations associated with encryption processing, the power analysis becomes more difficult.

The operation frequency of the clock supplied from the first clock circuit 8a can be made to change before or while the encryption circuit 5 performs arithmetic computations associated with encryption processing. The more times the operation frequency of the clock supplied from the first clock circuit 8a is made to change, the more difficult the power analysis becomes. In a variant, the information processing device can include two or more clock circuits constructed as shown in FIG. 12 or 13, which are used for supplying clocks to a CPU 1, public key cryptography processing, and private key cryptography processing, respectively.

As mentioned above, in accordance with the sixth embodiment of the present invention, since the clock to be supplied to the encryption circuit 5 from the first clock circuit 8 is made to change according to the random number generated by the random number generation circuit 7, the encryption circuit 5 changes in its operating electric power according to the random number every time the encryption circuit 5 performs arithmetic computations associated with the encryption processing, thereby making it more difficult to estimate the key data through power analysis.

### Embodiment 7

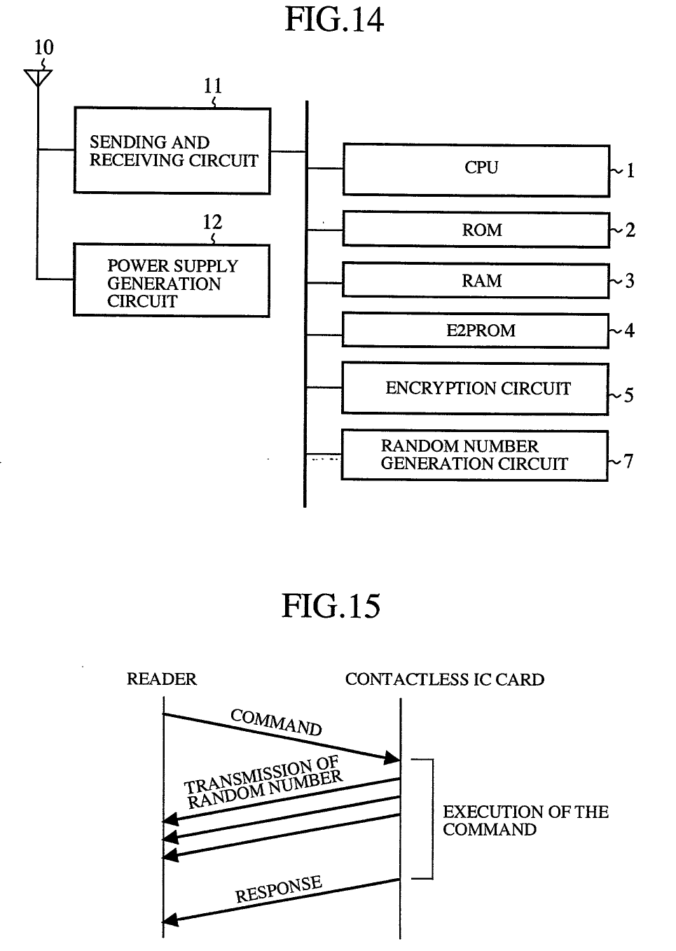

FIG. 14 is a block diagram showing an information processing device according to a seventh embodiment of the present invention. In the figure, a contactless IC card having a built-in security function is illustrated as an example of the information processing device of the seventh embodiment. In the figure, reference numeral 10 denotes an antenna that sends and receives an electric wave to and from a reader (not shown), reference numeral 11 denotes a sending and receiving circuit for sending and receiving transmission data from and to the contactless IC card byway of the antenna 10, and reference numeral 12 denotes a power supply generation circuit for generating power from the electric wave received by way of the antenna 10.

In operation, the contactless IC card performs AM modulation and AM demodulation by mean of the sending and receiving circuit 11, and performs data transmission with a reader (not shown). Power required for the contactless IC card to operate is generated from an electric wave received by way of the antenna 10 by the power supply generation circuit 12, and is then supplied to the sending and receiving circuit 11, a CPU 1, an encryption circuit 5, a random number generation circuit 7, and so on.

FIG. 15 is timing chart showing the timing at which data are transmitted between the contactless IC card and a reader (not shown) when a command accompanied by encryption processing is executed. First, the sending and receiving circuit 11 receives a command accompanied by encryption processing and transmitted from the reader by way of the antenna 10. The sending and receiving circuit 11 demodulates and sends the received command to the CPU 1, and the CPU 1 processes the command. When the execution of the command is ended, the sending and receiving circuit 11 AM-modulates execution results and then transmits the AM-modulated execution results to the reader by way of the antenna 10.

While the CPU 1 executes an encryption processing program during the execution of the command, the random number generation circuit 7 generates a random number, and the sending and receiving circuit 11 AM-modulates the random number and transmits the AM-modulated random number to the reader. Thus, the transmission of the random number during the execution of the command accompanied by encryption processing makes it difficult to monitor a Vcc line because a random noise is generated in the Vcc line.

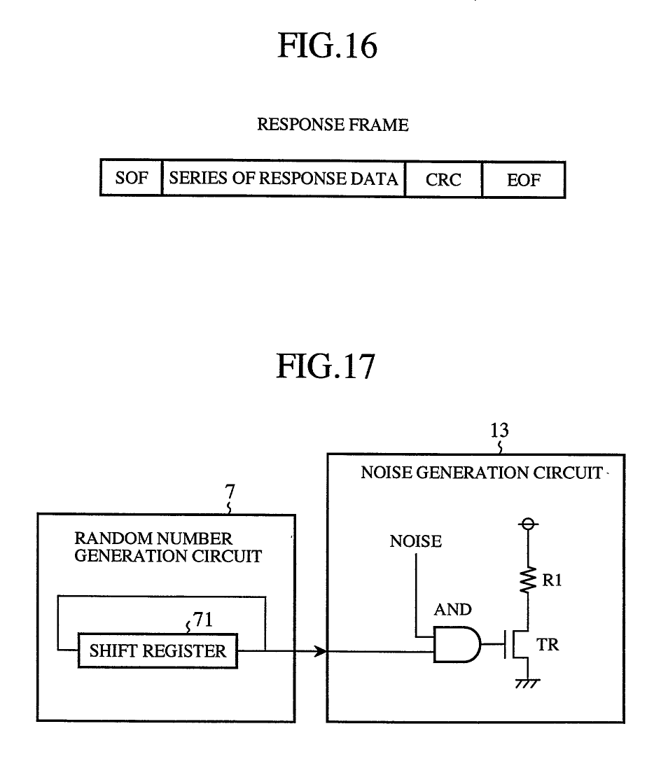

FIG. 16 is a drawing showing the structure of a response frame indicating execution results of a command accompanied by encryption processing which is sent to the reader when the execution of the command is completed. As shown in the figure, since an SOF code indicating the head of the response frame, an EOF code indicating the end of the response frame, and a CRC code for communication error check are added to the response frame, the random number is not misidentified as any response on the reader side.

When a contactless IC card in which the degree of modulation can be controlled in the sending and receiving circuit 11 is used as the information processing device, the degree of modulation can be changed according to the random number generated by the random number generation circuit 7. Thus, the determination of the degree of modulation by using the random number can change the magnitude of the random noise generated in the Vcc line. The transmission rate having the same frequency as the operation frequency of the encryption circuit enhances the effect. Furthermore, when the transmission rate and the operation frequency of the encryption circuit are set so that they are the same as the frequency of an electric wave received by way of the antenna, the random noise generated in the Vcc line and ripples caused by rectification overlap one another and this results in enhancing the above-mentioned effect.

As mentioned above, in accordance with the seventh embodiment of the present invention, since the contactless IC card transmits a random number to a reader while performing encryption processing, the contactless IC card can cause a random noise in the Vcc line, thereby making it more difficult to estimate the key data through power analysis.

### Embodiment 8

FIG. 17 is a block diagram showing an example of a noise generation circuit for use in an information processing device according to an eighth embodiment of the present invention. In the figure, reference numeral 7 denotes a random number generation circuit, reference numeral 71 denotes a shift register disposed in the random number generation circuit 7, and reference numeral 13 denotes a noise generation circuit for superimposing a noise on a Vcc line according to a random number generated by the random number generation circuit 7. The noise generation circuit is provided with an AND gate AND for opening or closing a path through which the noise is passed according to the random number generated by the random number generation circuit 7, a field-effect transistor TR having a gate terminal connected to an output terminal of the AND gate AND, and a resistor R1 connected to the field-effect transistor TR.

The information processing device, such as a contact IC card without a modulation circuit included in a contactless IC card, has the built-in noise generation circuit 13, as shown in FIG. 17, for generating a noise according to a random number generated by the random number generation circuit 7 and for superimposing the noise on the Vcc line. The random number generation circuit 7 sends the random number to the noise generation circuit 13 bit by bit by means of the shift register 71. The AND gate AND of the noise generation circuit 13 is opened when the input random number is at a high level, and is closed when the input random number is at a low level. Therefore, when the random number from the random number generation circuit 7 is at a high level, the power consumption increases, whereas when the random number is at a low level, the power consumption has a usual value.

The noise generation circuit 13 shown in FIG. 17 can change the resistance of the series circuit that consists of the field-effect transistor TR and the resistor R1 connected in series between the Vcc line and a ground according to the random number by applying the noise generated therein to the gate terminal of the field-effect transistor TR according to the random number, so that the noise whose level can change at random is superimposed on the Vcc line. It is therefore possible to change the resistance of the series circuit at random according to the random number by changing the gate voltage of the field-effect transistor TR according to the random number. Because the level of the noise that thus changes at random according to the random number is superimposed on the Vcc line and hence the power consumption changes, the estimation of the key data through power analysis becomes more difficult.

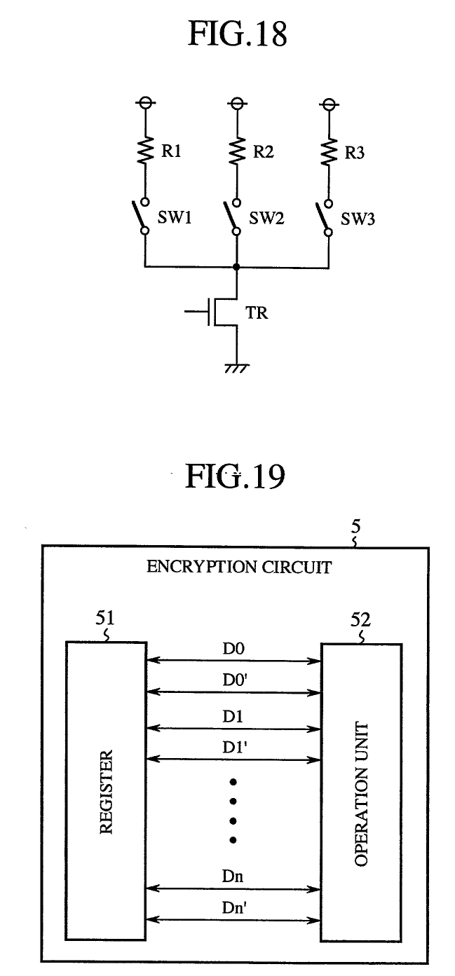

The noise generation circuit used by the eighth embodiment of the present invention is not limited to the one as shown in FIG. 17. As an alternative, a plurality of resistors can be connected to a field-effect transistor by way of switches, respectively. FIG. 18 is a circuit diagram showing an example of such a noise generation circuit. In the figure, TR denotes the field-effect transistor, R1 to R3 denote the resistors, and SW1 to SW3 denote switches.

In the noise generation circuit constructed as shown in FIG. 18, the connection of the three resistors R1 to R3 between the field-effect transistor TR and the Vcc line can be changed by controlling the switches SW1 to SW3 according to a 3-bit random number so that the resistance of the parallel circuit constructed of the plurality of resistors R1 to R3 connected in series to the field-effect transistor TR changes according to the random number. As a result, the resistance of the series circuit that consists of the field-effect transistor TR and the plurality of resistors R1 to R3 connected between the Vcc line and a ground changes according to the random number. Therefore, since the level of the noise superimposed on the Vcc line changes at random according to the random number, the estimation of the key data through power analysis becomes difficult. The transmission rate having the same frequency as the operation frequency of the encryption circuit enhances the effect. Furthermore, when the transmission rate and the operation frequency of the encryption circuit are set so that they are the same as the frequency of an electric wave received by way of the antenna, the random noise generated in the Vcc line and ripples caused by rectification overlap one another and this results in enhancing the above-mentioned effect.

As mentioned above, in accordance with the eighth embodiment of the present invention, since in the noise generation circuit the resistance of the series circuit that consists of a field-effect transistor TR and at least a resistor is changed according to a random number generated by the random number generation circuit, a noise whose level changes at random according to the random number is superimposed on the Vcc line and hence the power consumption changes, thereby making it more difficult to estimate the key data through power analysis.

### Embodiment 9

FIG. 19 is a block diagram showing the structure of an encryption circuit for use in an information processing device according to a ninth embodiment of the present invention. In the figure, reference numeral 5 denotes an encryption circuit, reference numeral 51 denotes a register disposed in the encryption circuit 5, and reference numeral 52 denotes an operation unit of the encryption circuit 5.

In operation, any data D (D0 to Dn), such as key data or arithmetic computation result data, which is transmitted between the register 51 and the operation unit 52, is transmitted together with corresponding inverted data D′ (D0′ to Dn′), which is the inversion of the data D, by way of a pair of lines. When any data D and corresponding inverted data D′ are thus transmitted with them paired with each other, the numbers of 1s and 0s included in the data D and the corresponding inverted data D′ transmitted are equal to each other. Therefore, even when any data D is transmitted between the register 51 and the operation unit 52, the power consumption does not change according to how many the data D includes 1s and 0s, unlike the case where only the data D is transmitted.

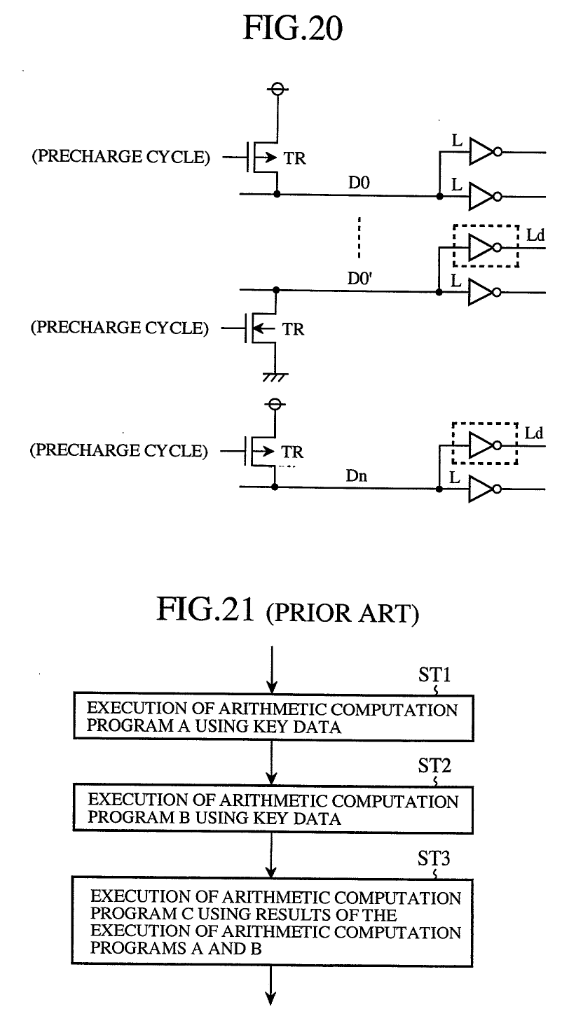

Referring next to FIG. 20, there is illustrated a schematic circuit diagram showing transmission of data D in the encryption circuit 5 according to the ninth embodiment. In the figure, L denotes a load circuit disposed on a line, Ld denotes a dummy circuit connected to a line, and TR denotes a transistor for precharging a corresponding line.

When any data D is transmitted between the register 51 and the operation unit 52, there is a possibility that which line changes in voltage can be guessed through analysis of the power consumption if the load imposed on the line via which the data D is transmitted is not equal to the load imposed on the corresponding line via which corresponding inverted data D′ is transmitted. Therefore, in the ninth embodiment, a dummy circuit Ld is connected to every line with fewer load circuits L, as shown in FIG. 20, even though the dummy circuit Ld is not needed under normal operating conditions. As a result, the load imposed on every line becomes nearly equal.

Furthermore, when, after making data D and corresponding inverted data D′ propagate through the pair of lines, making next data D and corresponding inverted data D′ propagate through the pair of lines while leaving the pair of lines intact as it is, the power consumption differs according to the numbers of 1s and 0s included in the previous data D and corresponding inverted data D′ and it therefore becomes easy to perform power analysis. Therefore, in the ninth embodiment, a precharging cycle used for setting and keeping the pair of lines at an identical state is provided prior to any data transmission as shown in FIG. 20. In other words, in the precharging cycle, the line via which the next data D is to be transmitted is set to a high level by a corresponding transistor TR, and the line via which the corresponding inverted data D′ is transmitted is set to a low level by a corresponding transistor TR.

As mentioned above, in accordance with the ninth embodiment of the present invention, since any data D is transmitted between the register 51 and the operation unit 52 together with corresponding inverted data D′, which is the inversion of the data D, by way of a pair of lines, and the loads imposed on the pair of lines are equalized and a precharge is carried out prior to the transmission of any data, the power consumption does not depend on the numbers of 1s and 0s included in the transmitted data D, and hence becomes constant. Consequently, the encryption circuit of the present embodiment makes it more difficult to estimate the key data through power analysis.

### Embodiment 10

An information processing device according to a tenth embodiment of the present invention has a combination of any one of the function according to the first embodiment of storing the first half of each word of the key data and data which is the inversion of the first half of each word of the key data in one word of the E2PROM, storing the second half of each word of the key data and data which is the inversion of the second half of each word of the key data in another word adjacent to the word of the E2PROM in which the first half of each word of the key data and the corresponding inverted data are stored, and reading the key data together with the inverted data with the number of 1s included in the key data and the inverted data being equal to the number of 0s included in the key data and the inverted data, the function according to the second embodiment of changing the order in which the arithmetic computation programs A and B included in the encryption processing program are executed according to a random number, the function according to the fourth embodiment of reading the plurality of bytes of the key data on a byte-by-byte basis in the order determined by random numbers, and the function according to the fifth embodiment of generating a clock to be supplied to the encryption circuit and another clock to be supplied to the CPU by means of the first and second clock circuits disposed independently of each other, and the function according to the seventh embodiment of transmitting a random number to a reader during the execution of a command accompanied by encryption processing and/or the function according to the eighth embodiment of superimposing a noise on the Vcc line according to a random number.

Therefore the tenth embodiment offers an advantage of providing a higher level of security at a low cost with the combination.

Many widely different embodiments of the present invention may be constructed without departing from the spirit and scope of the present invention. It should be understood that the present invention is not limited to the specific embodiments described in the specification, except as defined in the appended claims.

What is claimed is:

1. An information processing device comprising:
a storage circuit for storing key data used to perform encryption processing for data security as well as inversion of the key data; and
an encryption processing circuit for reading the key data together with the inversion of the key data from said storage circuit, and for performing the encryption processing by using the key data read out of said storage circuit.

2. The information processing device according to claim 1, wherein said encryption processing circuit includes an encryption circuit for performing arithmetic computations associated with the encryption processing, and said encryption circuit has a line via which data such as the key data is transmitted, another line via which inverted data which is inversion of said data is transmitted, and a precharging circuit for precharging said line and said other line at certain levels, respectively, in a precharging cycle prior to transmission of said data and said other data via said line and said other line.

3. An information processing device comprising:
a storage circuit for storing key data used to perform encryption processing for data security;
a random number generation circuit for generating a random number; and
an encryption processing circuit for reading the key data from said storage circuit and for performing the encryption processing by using the key data read out of said storage circuit while changing a order in which two or more arithmetic computations associated with the encryption processing are performed according to the random number generated by said random number generation circuit.

4. The information processing device according to claim 3, wherein said encryption processing circuit includes an encryption circuit for performing arithmetic computations associated with the encryption processing, and said encryption circuit has a line via which data such as the key data is transmitted, another line via which inverted data which is inversion of said data is transmitted, and a precharging circuit for precharging said line and said other line at certain levels, respectively, in a precharging cycle prior to transmission of said data and said other data via said line and said other line.

5. An information processing device comprising:
a storage circuit for storing key data used to perform encryption processing for data security;
a random number generation circuit for generating a random number; and
an encryption processing circuit for reading the key data from said storage circuit and for performing the encryption processing by using the key data read out of said storage circuit while changing timing at which two or more arithmetic computations associated with the encryption processing are performed according to the random number generated by said random number generation circuit.

6. The information processing device according to claim 5, wherein said encryption processing circuit includes an encryption circuit for performing arithmetic computations associated with the encryption processing, and said encryption circuit has a line via which data such as the key data is transmitted, another line via which inverted data which is inversion of said data is transmitted, and a precharging circuit for precharging said line and said other line at certain levels, respectively, in a precharging cycle prior to transmission of said data and said other data via said line and said other line.

7. An information processing device comprising:
a storage circuit for storing key data used to perform encryption processing for data security;
a random number generation circuit for generating a random number; and
an encryption processing circuit for sequentially reading a plurality of parts of the key data one after another from said storage circuit while determining a part of the key data to be read for the next time according to the random number generated by said random number generation circuit, and for performing the encryption processing by using the key data read out of said storage circuit.

8. The information processing device according to claim 7, wherein said encryption processing circuit includes an encryption circuit for performing arithmetic computations associated with the encryption processing, and said encryption circuit has a line via which data such as the key data is transmitted, another line via which inverted data which is inversion of said data is transmitted, and a precharging circuit for precharging said line and said other line at certain levels, respectively, in a precharging cycle prior to transmission of said data and said other data via said line and said other line.

9. An information processing device comprising:
a storage circuit for storing key data used to perform encryption processing for data security;
an encryption processing circuit for reading the key data from said storage circuit and for performing the encryption processing by using the key data read out of said storage circuit;
an arithmetic computation circuit for performing specific arithmetic computations associated with the encryption processing performed by said encryption processing circuit;
a first clock generation circuit for supplying a clock to said arithmetic computation circuit; and
a second clock generation circuit for supplying another clock different from the clock generated by said first clock generation circuit to said encryption processing circuit;

10. The information processing device according to claim 9, further comprising a random number generation circuit for generating a random number, wherein said first clock generation circuit changes a frequency of the clock generated thereby according to the random number generated by said random number generation circuit.

11. The information processing device according to claim 9, wherein said encryption processing circuit includes an encryption circuit for performing arithmetic computations associated with the encryption processing, and said encryption circuit has a line via which data such as the key data is transmitted, another line via which inverted data which is inversion of said data is transmitted, and a precharging circuit for precharging said line and said other line at certain levels, respectively, in a precharging cycle prior to transmission of said data and said other data via said line and said other line.

12. An information processing device that sends and receives data to and from a reader, said device comprising:
a storage circuit for storing key data used to perform encryption processing for data security;
a random number generation circuit for generating a random number;
an encryption processing circuit for reading the key data from said storage circuit and for performing the encryption processing by using the key data read out of said storage circuit; and
a transmission circuit for transmitting the random number generated by said random number generation circuit to said reader while said encryption processing circuit performs the encryption processing by using the key data.

13. The information processing device according to claim 12, where said transmission circuit determines a degree of modulation with which said transmission circuit modulates the random number generated by said random number generation circuit when transmitting the random number to said reader according to the random number.

14. The information processing device according to claim 12, wherein said encryption processing circuit includes an encryption circuit for performing arithmetic computations associated with the encryption processing, and said encryption circuit has a line via which data such as the key data is transmitted, another line via which inverted data which is inversion of said data is transmitted, and a precharging circuit for precharging said line and said other line at certain levels, respectively, in a precharging cycle prior to transmission of said data and said other data via said line and said other line.

15. An information processing device comprising:
a storage circuit for storing key data used to perform encryption processing for data security;
a random number generation circuit for generating a random number;
an encryption processing circuit for reading the key data from said storage circuit and for performing the encryption processing by using the key data read out of said storage circuit; and; and
a noise superimposing circuit for superimposing a noise on a power supply line according to the random number generated by said random number generation circuit.

16. The information processing device according to claim 15, wherein said noise superimposing circuit includes a series circuit having a field-effect transistor and at least a resistor connected in series to said field-effect transistor, and connected between a power supply line and a ground, and a circuit for changing a resistance of said series circuit according to the random number generated by said random number generation circuit.

17. The information processing device according to claim 15, wherein said encryption processing circuit includes an encryption circuit for performing arithmetic computations associated with the encryption processing, and said encryption circuit has a line via which data such as the key data is transmitted, another line via which inverted data which is inversion of said data is transmitted, and a precharging circuit for precharging said line and said other line at certain levels, respectively, in a precharging cycle prior to transmission of said data and said other data via said line and said other line.
